(19) United States
(12) Patent Application Publication
(10) Pub. No.: US 2024/0101116 A1
(43) Pub. Date: Mar. 28, 2024

(54) METHOD FOR AUTOMATICALLY SUPPORTING A MOTOR VEHICLE FOR TRAVERSING AN EXIT OF A MAIN ROAD

(71) Applicant: AUDI AG, Ingolstadt (DE)

(72) Inventor: Ingo TOTZKE, Ingolstadt (DE)

(73) Assignee: AUDI AG, Ingolstadt (DE)

(21) Appl. No.: 17/766,457

(22) PCT Filed: Oct. 8, 2020
(86) PCT No.: PCT/EP2020/078228

§ 371 Date: Jun. 30, 2022

(30) Foreign Application Priority Data
Oct. 11, 2019 (DE) 10 2019 127 410.9

(51) Int. Cl. B60W 30/18

(52) U.S. Cl. CPC B60W 30/18145; B60W 30/18109; B60W 2554/4041; B60W 2554/4045; B60W 2554/4046

(57) ABSTRACT

The disclosure relates to a method for automatically assisting a motor vehicle when driving on an exit of a main road. A current position of the motor vehicle is detected, and imminent driving onto the exit is recognized. Geometric data of the exit are obtained from a first database based on the current position. Current information regarding road conditions and a traffic situation at the exit is recorded and/or is obtained from a second database. A critical speed and/or a parameter for a cornering behavior of the motor vehicle is determined, based on the geometric data and the current information. At least one warning signal is output and/or a braking operation is controlled depending on the determined critical speed and/or the determined parameter for cornering behavior.

### TECHNICAL FIELD

The disclosure relates to a method for automatically assisting a motor vehicle for driving on an exit of a main road, wherein it is detected that driving on the exit is imminent, and wherein at least one warning signal is output and/or a braking operation is activated.

### BACKGROUND

Driving off of a main road, for example a freeway, a multi-lane federal highway or another expressway, often poses a particular challenge for a driver of a motor vehicle, since when driving on an exit of an expressway the speed usually has to be reduced as a result of a curve at the exit. However, the current speed is often underestimated by the driver because he has become used to the higher speeds of the expressway. This can lead to abrupt steering and/or braking maneuvers when exiting or even to leaving the route, which can also endanger other road users.

The situation often becomes even more unfavorable for a driver because, as a result of a curve at the exit, there is an end of a tailback at the exit, a shortening or narrowing of the lane width at the exit (e.g. due to construction works), but also a change in the road conditions (e.g. sudden slippery roads or wet conditions) cannot be seen from the start.

For a vehicle combination with a trailer, as a result of the increased weight and the changes in steering behavior caused by the trailer, an unexpected reaction of the towing vehicle can occur in a curve on the exit, which additionally makes control difficult.

### BRIEF DESCRIPTION OF THE DRAWINGS/FIGURES

FIG. 1 is a plan view of a vehicle combination driving on an exit of a main road, according to some embodiments of the present disclosure.

### DETAILED DESCRIPTION

It is an object of the present disclosure to provide a method for a motor vehicle by which driving on an exit of a main road is to be achieved.

The object is achieved according to the disclosure by a method for automatically assisting a motor vehicle when driving onto an exit of a main road, wherein a current position of the motor vehicle is determined, wherein imminent driving onto the exit is detected, wherein geometric data of the exit are obtained from a first database on the basis of the current position, and wherein current information is obtained from a second database with regard to road conditions at the exit and/or with regard to a traffic situation at the exit and/or on the basis of the current position. In this case, a critical speed for driving the vehicle onto the exit and/or determining a parameter for cornering behavior of the motor vehicle is determined based on the geometric data of the exit and based on the information regarding the road conditions at the exit or regarding the traffic situation at the exit and, depending on the determined critical speed and/or the determined parameter for cornering behavior, at least one warning signal is output and/or a braking operation is activated. Advantageous designs and embodiments which are partly inventive when considered alone are the subject matter of the dependent claims.

A main road includes, in particular, a freeway and a federal road as well as any other expressway. In particular, on the main road an expected average speed and/or a maximum permitted speed for the motor vehicle which is usual in normal traffic conditions is significantly higher than a maximum permitted speed at the exit and/or a speed required for safe driving there. In this case, the exit has, in particular, at least one curve leading away from the main road.

In this case, a motor vehicle comprises in particular a passenger car or truck and a vehicle combination of a car or truck and a trailer, wherein the trailer is towed by the car or truck in the vehicle combination.

The current position of the motor vehicle is preferably determined by a satellite-based positioning system, for example GPS, which is implemented in particular in a navigation system of the motor vehicle. For this purpose, the determination of the position preferably includes assigning the motor vehicle a location on a high-resolution map, such as an HD map, which shows the main road and its surroundings.

Imminent driving onto the exit means in particular that, in the context of the route planning in the navigation system of the vehicle or by an input by the driver of the motor vehicle and/or by sensors of the motor vehicle, driving on the exit is assumed with a sufficiently high degree of certainty, and reaching the exit is imminent, for example in less than 1 km, preferably less than 500 m. Imminent driving onto an exit can be detected based on an input by the driver, for example, based on a turn signal being set, but also by a voice input from the driver. Detection by sensors of the motor vehicle can take place, for example, in that sensors detect driving in a deceleration lane leading to the exit and interpret it accordingly.

The first database comprises, in particular, a high-resolution map with geometric data for a large number of possible exits, so that the relevant geometric data for the exit that is imminent can be obtained based on the current position. In this case, the first and the second database are implemented, in particular, on a memory separate from the motor vehicle, for example in a cloud, so that the geometric data can be obtained by the vehicle via a corresponding communication connection, in particular via an Internet connection. However, the first database can also be stored entirely locally in the vehicle, for example in a data memory of the navigation system, or in a native memory provided specifically for this purpose.

In this case, the second database is preferably supplied with corresponding current information which has been recorded by other motor vehicles using their vehicle sensors. However, the motor vehicle can also record the information itself with regard to the road conditions and/or with regard to the traffic situation in the exit if appropriately equipped sensors, for example in the form of cameras, etc., are arranged on the motor vehicle for this purpose. Information regarding the road conditions includes, in particular, information about wetness and/or slippery roads, or also about the type of roadway surface and, in particular, about a change in the roadway surface at the exit. Information regarding a traffic situation includes, in particular, information about other vehicles that may be backed up at the exit. Obtaining the information from the second database is particularly advantageous in the case of exits which can only be insufficiently detected by the sensors of the motor vehicle due to vegetation or buildings in the interior area of a curve.

The critical speed or the parameter for the cornering behavior of the motor vehicle is also preferably determined based on previously recorded data relating to the weight and/or the dimensions of the motor vehicle. The data relating to the weight and/or the dimensions of the motor vehicle can be predetermined using the corresponding values known from the construction of the motor vehicle, wherein the value of the weight can be adapted by a user input with regard to an estimated load, and, if applicable, the length of a trailer coupled to a towing vehicle of known length can be taken into account by a further user input.

The geometric data of the exit include, in particular, a radius of curvature, a roadway width, a length of the exit, a number of lanes, a length of the exit, an angle of inclination, a height profile and/or an uphill gradient or a downhill gradient.

If it is now detected that driving on an exit of the main road is imminent, based on the geometric data of the exit which have been obtained from the first database, and based on the information concerning the road conditions or the traffic situation at the exit, a critical speed and/or a parameter for the cornering behavior is determined which, in particular, can include a value of a transverse acceleration of the motor vehicle or, in the case of a vehicle combination, also a speed-dependent probability of the trailer swerving. In particular, a transverse acceleration of the motor vehicle can also be determined first and used for the critical speed. The critical speed can be determined, for example, as a curve speed limit of the motor vehicle at the exit. If a tailback is detected based on the information regarding the traffic situation at the exit, the critical speed can be determined based on a distance to the end of a traffic jam and based on possible braking distances.

If the critical speed exceeds a recorded current speed of the vehicle, the automatic assistance function intervenes by issuing the warning signal to the driver in a form that he can safely perceive, e.g. via a signal tone and/or a voice output of a warning message, or via a signal light or other visual display, for example on a screen of the navigation system. In addition or as an alternative to this, the automatic assistance function can control a braking operation, for example by outputting a control signal which controls a brake in such a way that the braking force is sufficiently high to prevent a collision or to avoid leaving the lane at the exit under the prevailing traffic and weather conditions. In this case, the brake is preferably actuated with the braking force without significantly exceeding this described braking force. This avoids unnecessarily abrupt braking behavior.

Advantageously, imminent driving onto the exit is detected using route planning by a navigation system of the motor vehicle in connection with the current position of the motor vehicle and/or by setting a turn signal, in particular in connection with a visual detection of driving in a right-hand lane of a plurality of lanes, and/or based on detection of driving in a deceleration lane leading to the exit. This allows detection with a sufficiently high degree of certainty, so that, in particular, the cases in which automatically assisted driving that is actually required is wrongly omitted (i.e. errors of the first type) can be minimized.

At least one of the following items of information is preferably obtained as geometric data of the exit: a radius of curvature, a roadway width, a number of lanes, a length of the exit, an angle of inclination, an uphill gradient, a downhill gradient. In this case, it is particularly preferable for a large number of the items of information for the exit to be obtained as geometric data. The information allows the braking and cornering behavior of the motor vehicle at the exit to be calculated and enables the length and width of the space available for the motor vehicle to be taken into account.

It proves to be further advantageous if the current information regarding the road conditions at the exit and/or regarding the traffic situation at the exit is obtained from the second database as swarm data information. This means, in particular, that corresponding information from a number of other motor vehicles is recorded by their sensors and fed into the second database. In particular, the swarm data information can be pre-processed in such a way that the motor vehicle obtains information from the second database that has been pre-processed to the effect that a decision or weighting of individual data which has been recorded by different motor vehicles and fed into the second database can be carried out in the second database itself. As a result, the motor vehicle can, on the one hand, access the “knowledge” of the other motor vehicles with regard to the road conditions and/or the traffic situation without having to carry out complex evaluations.

A vehicle combination with at least one trailer is advantageously assisted as the motor vehicle. In this case, the trailer is, in particular, a transport trailer for transporting loads, sports equipment, a watercraft, at least one bicycle, or at least one animal. It is also possible that the trailer is a caravan.

In particular, a transverse acceleration of the vehicle combination and/or a parameter that describes swerving of the trailer is determined as a parameter for cornering behavior, wherein the transverse acceleration can also be determined separately for the towing vehicle and the trailer. The parameter for swerving of the trailer can be given, for example, by a speed-dependent probability value for such swerving, and can be determined, in particular, from the transverse acceleration for the motor vehicle or for the towing vehicle and the trailer. The towing vehicle of the vehicle combination is in particular a car or a truck. Due to the trailer, vehicle combinations have a cornering behavior that is often difficult to estimate, since the trailer reacts to steering movements with a delay and also transfers its inertia to the towing vehicle via the coupling. The present method is therefore particularly suitable for taking this unexpected cornering behavior into account and for increasing driving safety at exits.

In this case, a function for stabilizing the trailer through automatically assisted steering is preferably activated, in particular when there is a threat of the trailer swerving, which is detected using sensors or is determined by calculation, depending on the determined critical speed and/or the determined parameter for cornering behavior. If, for example, a rear-facing camera detects that the trailer is at risk of leaving the curve of the exit, counter-steering of the vehicle can be activated automatically, in order to prevent complete swerving, in particular in addition to a braking operation.

In an advantageous embodiment, location-related information entered on a map and/or a visual warning, in particular as text, is used as a warning signal via a display and/or via a projection, output in particular on/into the windscreen and/or on the roadway in front of the motor vehicle, and/or at least one signal tone and/or a warning message generated by voice output is output. These types of warnings are particularly easy for the driver of the motor vehicle to perceive without his attention being impaired by the traffic situation.

A current speed of the motor vehicle is advantageously determined, wherein at least one braking distance is determined according to the current speed, in particular also depending on the road conditions and/or the parameter for cornering behavior, and wherein the critical speed is determined according to the at least one braking distance. If the motor vehicle is a vehicle combination, the at least one braking distance is preferably also determined according to the weight and/or the length and/or the width of the trailer of the vehicle combination. The critical speed can be determined, for example, as the current speed that must not be exceeded at a reference point at the exit, wherein the reference point is located before the end of a traffic jam by at least the determined braking distance, wherein an additional safety distance can be taken into account, if applicable.

A first braking distance and an associated critical speed for a comfort braking operation and a second braking distance and an associated critical speed for an emergency braking operation are preferably determined according to the current speed, and in particular also according to the road conditions and/or the parameter for cornering behavior, wherein if the critical speed for the first braking distance is exceeded, the at least one warning signal is output and/or the braking operation is controlled with a reduced braking power, and wherein if the critical speed for the second braking distance is exceeded, full braking is controlled.

A reduced braking power is to be understood here, in particular, as a braking power that is measurably reduced with respect to the maximum braking power, which corresponds to full braking. In this case, the second braking distance is preferably calculated as a braking distance for an emergency braking operation that takes place under the prevailing external conditions. The first braking distance of the comfort braking operation is determined here, in particular, based on previously stored parameters with regard to a braking power still perceived as pleasant by the driver, which in turn can be determined by test series or the like. The procedure described can ensure that the emergency braking operation is then activated only when it is necessary, and otherwise only the driver receives the warning or the motor vehicle is braked with the moderate comfort braking operation.

The disclosure further relates to a motor vehicle, comprising: means for detecting a current position, means for obtaining information from a database that is, in particular, separate from the motor vehicle, means for outputting a warning signal and/or means for outputting a braking signal, and a control unit which is set up to use the detected current position and at least to carry out the method described above based on geometric data of an exit of a main road obtained from a first database and based on current information with regard to road conditions at the exit and/or with regard to a traffic situation at the exit. The motor vehicle shares the advantages of the method according to the disclosure. The advantages specified for the method and for further developments thereof can be transferred analogously to the motor vehicle.

An embodiment of the disclosure is explained in more detail below with reference to a drawing.

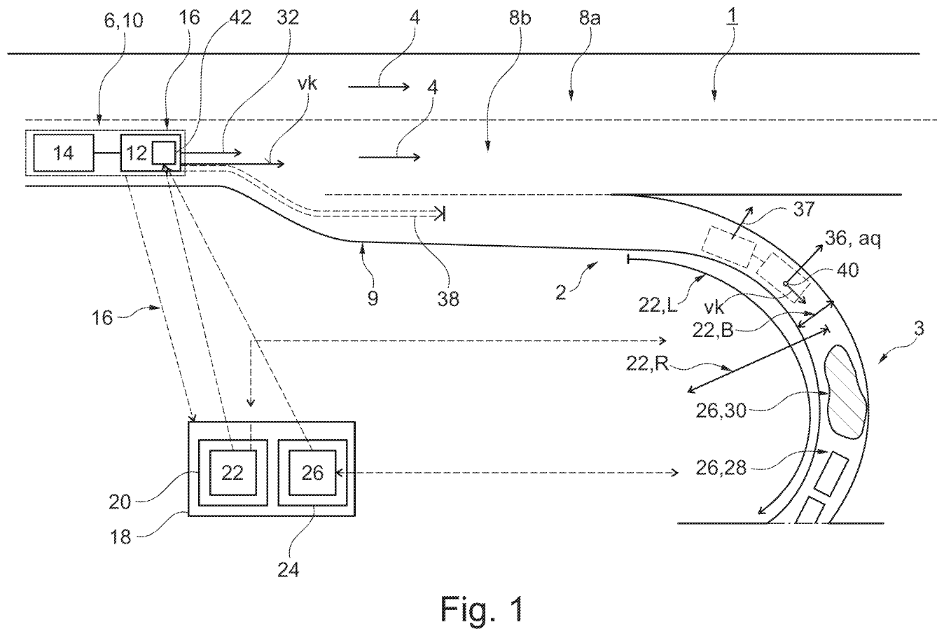

In FIG. 1, a main road 1, from which an exit 2 leads away in a curve 3, is shown schematically in a plan view. The main road 1 has two lanes 8a, 8b in a travel direction 4 of a motor vehicle 6 and a deceleration lane 9 leading to the exit 2. In the present embodiment, the motor vehicle 6 is a vehicle combination 10 with a towing vehicle 12 and a trailer 14 coupled to the towing vehicle 12. In this case, the towing vehicle 12 may be a car or a truck. The trailer 14 can be designed, in particular, as a transport trailer for transporting loads, sports equipment, watercraft or animals, or, in the case where the towing vehicle 12 is a car, also as a caravan. The motor vehicle 6 has a navigation system (not shown) which, among other things, continuously determines a current position 16 of the motor vehicle 6 and uses this for internal route planning and assistance functions of the navigation system. The current position 16 can be determined using a GPS system or the like.

Based on the route planning of the navigation system and based on the current position 16 of the motor vehicle 6, or also based on the setting of a right turn signal while driving on the deceleration lane 9, or by detection of driving in the deceleration lane 9, it can now be detected that the car 6 will imminently be driving on the exit 2. The detection can take place, for example, in that at least one of the criteria listed here is considered to be met, in which case it may also be required that the distance between the current position 16 and the exit 2 falls below a threshold value, so that driving on the exit is now classified as imminent.

The current position 16 is now transmitted to a central server 18, which can be done, for example, via an Internet connection of the motor vehicle and a corresponding transmission protocol. On the basis of the current position 16, geometric data 22 of the forthcoming exit 2 are provided from a first database 20 in the central server 18, which can also be formed from a plurality of physically separate units. The geometric data 22 can include, in particular, a radius of curvature R, a roadway width B at the exit 2, a length L and, if applicable, information about an uphill gradient, a downhill gradient or an incline (not shown) of the roadway at the exit 2.

Current information 26 concerning the road conditions and the traffic situation at the exit 2 is stored in a second database 24 of the central server. This current information 26 is recorded as swarm data information by a large number of vehicles through their respective sensors, and is continuously fed into the second database 24 in order to update the information. Information concerning a traffic situation, specifically in the form of an end of a traffic jam 28 at the exit 2, and concerning the road conditions, specifically in the form of a wet roadway 30 at the exit 2, is stored as current information 26 in the second database 24. The geometric data 22 of the first database 20 and the current information 26 of the second database 24 are now transmitted to the motor vehicle 6 and processed there in a control unit 42.

A current speed 32 of the motor vehicle 6 is now recorded and, on the basis of this, as well as on the basis of the geometric data 22 of the exit and the current information 26, parameters 36 for the cornering behavior of the motor vehicle 6 and a critical speed vk are determined. For this purpose, firstly a transverse acceleration aq in the curve 3 of the exit 2 is determined as a parameter 36 using the geometric data 22 of the exit. A critical speed vk, above which the motor vehicle 6 can no longer be kept in the curve by steering movements, is determined based on the transverse acceleration aq, the current information 26 about the wet roadway 30 and the weight of the motor vehicle 6. As a further parameter 36, the probability value for swerving 37 of the trailer 14 can be determined when the motor vehicle 6 drives into a position 40 in the curve 3. In addition, a braking distance 38 for the motor vehicle 6 is determined based on the current speed 32, the current information 26 about the end of the traffic jam 28 and the wet road surface 30, and based on the weight of the motor vehicle 6. In this case, it is determined that the braking distance 38 is sufficient to bring the motor vehicle 6 to a standstill before the end 28 of the traffic jam. Analogously to the procedure described, a critical speed vk can be determined for each point in the exit depending on the end 28 of the traffic jam, for which the braking distance 38 would lead exactly to the end 28 of the traffic jam.

If a critical speed vk is now exceeded by the current speed 32 of the vehicle 6, this is indicated to the driver of the vehicle 6, for example by a warning on a display of the navigation system (not shown), or by the output of a signal tone or a spoken warning. Furthermore, a braking operation is controlled in such a way that the current speed 32 again falls below the critical speed vk—which can relate to leaving the curve 3 or to the end of a traffic jam 28.

Although the disclosure has been illustrated and described in detail by the preferred embodiment, the disclosure is not limited by this embodiment. Other variations can be derived from this by a person skilled in the art without departing from the scope of protection of the disclosure.

### LIST OF REFERENCE SIGNS

1 main road
2 exit
3 curve
4 travel direction
6 motor vehicle
8a, 8b lanes
9 deceleration lane
10 vehicle combination
12 towing vehicle
14 trailer
16 actual position
18 central server
20 first database
22 geometric data
24 second database
26 current information
28 end of a traffic jam
30 wet road
32 current speed
36 parameter
37 swerving
38 braking distance
40 position in the curve 3
aq transverse acceleration
B roadway width
B length
R radius of curvature
vk critical speed

1.-10. (canceled)

11. A method for automatically assisting a motor vehicle when driving on an exit of a main road, comprising:
determining a current position of the motor vehicle;
recognizing an imminent driving onto the exit;
obtaining, from a first database, geometric data of the exit based on the current position;
recording, and/or obtaining from a second database, current information regarding road conditions and/or a traffic situation at the exit based on the current position;
determining, based on the geometric data and the current information, a critical speed for driving on the exit by the motor vehicle and/or a parameter for a cornering behavior of the motor vehicle;
outputting a warning signal and/or controlling a braking operation according to the determined critical speed and/or the determined parameter for the cornering behavior.

12. The method according to claim 11, further comprising:
detecting the imminent driving onto the exit using a route planning by a navigation system of the motor vehicle in connection with the current position of the motor vehicle, and/or based on setting a turn signal, and/or based on detection of driving in a deceleration lane leading to the exit.

13. The method according to claim 11, wherein the obtaining of the geometric data of the exit comprises obtaining at least one of a radius of curvature, a roadway width, a number of lanes, a length of the exit, an angle of inclination, an uphill gradient, or a downhill gradient.

14. The method according to claim 11, wherein the obtaining of the current information comprises obtaining swarm data information.

15. The method according to claim 11, wherein the assisting of the motor vehicle comprises assisting a vehicle combination with a trailer.

16. The method according to claim 15, further comprising:
activating, by automatically assisted steering, a function for stabilizing the trailer based on the determined critical speed and/or the determined parameter for cornering behavior.

17. The method according to claim 11, the outputting of the warning signal comprises entering location-based information in a map, and/or outputting at least one of a visual warning, a signal tone, or a voice warning.

18. The method according to claim 11, further comprising:
determining a current speed of the motor vehicle;
determining a braking distance based on the current speed; and
determining the critical speed based on the braking distance.

19. The method according to claim 18, further comprising:
determining, according to the current speed, a first braking distance and a first critical speed associated with the first braking distance for a comfort braking operation;
determining, according to the current speed, a second braking distance and a second critical speed associated with the second braking distance for an emergency braking operation;
outputting the warning signal and/or controlling the braking operation with a reduced braking power if the current speed exceeds the first critical speed for the first braking distance; and
controlling the braking operation with a full braking power if the current speed exceeds the second critical speed for the second braking distance.

20. A motor vehicle, comprising:
a navigation system configured to detect a current position of the motor vehicle;
a communication device configured to obtain information from a database;
an output device configured to output a warning signal and/or a braking signal; and
a control unit configured to:
determine a critical speed for driving on an exit of a main road by the motor vehicle and/or a parameter for a cornering behavior of the motor vehicle based on geometric data of the exit and based on current information with regard to road conditions at the exit and/or with regard to a traffic situation at the exit; and
control a braking operation according to the determined critical speed and/or the determined parameter for the cornering behavior.

21. The motor vehicle of claim 20, wherein the navigation system is further configured to detect an imminent driving onto the exit using a route planning based on the current position of the motor vehicle.

22. The motor vehicle of claim 20, wherein the geometric data of the exit comprises a radius of curvature, a roadway width, a number of lanes, a length of the exit, an angle of inclination, an uphill gradient, or a downhill gradient.

23. The motor vehicle of claim 20, wherein the current information comprises swarm data information.

24. The motor vehicle of claim 20, wherein the motor vehicle comprises a vehicle combination with a trailer.

25. The motor vehicle of claim 20, wherein the control unit is further configured to activate, by automatically assisted steering, a function for stabilizing the trailer based on the determined critical speed and/or the determined parameter for cornering behavior.

26. The motor vehicle of claim 20, wherein the output device comprises a visual display and a voice output.

27. The motor vehicle of claim 20, wherein the control unit is configured to determine the critical speed based on a braking distance according to the current speed.

28. The motor vehicle of claim 20, wherein the control unit is further configured to:
determine, according to the current speed, a first braking distance and a first critical speed associated with the first braking distance for a comfort braking operation; and
determine, according to the current speed, a second braking distance and a second critical speed associated with the second braking distance for an emergency braking operation.

29. The motor vehicle of claim 28, wherein the output device is further configured to output the warning signal if the current speed exceeds the first critical speed for the first braking distance.

30. The motor vehicle of claim 28, wherein the control unit is further configured to:
control the braking operation with a reduced braking power if the current speed exceeds the first critical speed for the first braking distance; and
control the braking operation with a full braking power if the current speed exceeds the second critical speed for the second braking distance.
